(19) United States
(12) Patent Application Publication
(10) Pub. No.: US 2003/0187676 A1
(43) Pub. Date: Oct. 2, 2003

(54) Tool for developing a map of relevant business processes and flows

(76) Inventors: Stefan Hack, Wiesloch (DE); Liezl Schulte, Heidelberg (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/188,310

(22) Filed: Jul. 1, 2002

Related U.S. Application Data
(60) Provisional application No. 60/369,255, filed on Mar. 29, 2002.

(51) Int. Cl. G06F 17/60

(52) U.S. Cl. 705/1

(57) ABSTRACT

Techniques for deriving a map of relevant business processes includes receiving a user's selection of an industry or process category, providing a map of business processes relevant to the user's selection, modifying nomenclature, processes, process categories, main processes, or pool elements associated with the map in response to a user's selection, and providing a customized map of the relevant business processes.

### REFERENCE TO RELATED APPLICATION

This application claims priority from U.S. provisional patent application No. 60/369,255, filed on Mar. 29, 2002, entitled “Collaborative Network Planning Tools and Solution Composer,” which is incorporated herein by reference in its entirety.

### BACKGROUND

An industry is typically comprised of business entities that interact with other business entities. The business entities may include market participants who may use software tools to exchange information with other participants.

The market participants in an industry may have many business processes that are used to interact with other market participants. Business processes also include activities to achieve a specific business result.

The landscape of the economy in the present day often consists of a network of communities or virtual groups that share a common business goal defined by electronic collaboration in electronic commerce. “Collaboration” refers to creating value-generating business processes that extend beyond the boundaries of an enterprise. Collaboration also may affect traditional businesses such as the chemical, automotive, or other non electronic commerce based businesses. Collaboration combines one enterprise with various business participants from multiple industries in a value chain. A value chain often refers to a model of how businesses receive raw materials as input, add value to the raw materials through various processes, and sell finished products to customers. The value chain may consist of one or a few primary value (product or service) suppliers and other suppliers that may add to the value that is ultimately presented to the buying public. To achieve this goal, enterprises may need to share information and define responsibilities for specific activities. As such, the collaboration may span one or more enterprises.

### SUMMARY

In one aspect, a method is disclosed for deriving a map of relevant business processes that includes receiving a user's selection of an industry or process category, providing a map of business processes relevant to the user's selection, modifying nomenclature, processes, process categories, main processes, or pool elements associated with the map in response to a user's selection, and providing a customized map of the relevant business processes.

A second aspect is an article comprising a computer-readable medium storing computer-executable instructions that when applied to one or more computers causes the computers to perform the method disclosed above.

In a third aspect, a system is provided that includes one or more computers configured to perform the method disclosed above.

In a fourth aspect, a method is disclosed for deriving a business process flow that includes receiving a user's selection of one or more business process flows including market participants and activities, modifying at least one of market participants, activities, or pool elements associated with the business process flow in response to a user's selection, associating activities with participants, and providing a customized map of relevant process flows.

A fifth aspect is an article comprising a computer-readable medium storing computer-executable instructions that when applied to one or more computers causes the computers to perform the method disclosed above.

In a sixth aspect, a system is provided that includes one or more computers configured to perform the method disclosed above.

In a seventh aspect, a method is disclosed for linking relevant business processes and flows that includes providing a map of relevant business processes including a plurality of main processes, providing one or more business process flows, associating a plurality of main processes with one or more business process flows, and generating maps and process flows having main processes associatively linked to one or more business process flows.

An eighth aspect is an article comprising a computer-readable medium storing computer-executable instructions that when applied to one or more computers causes the computers to perform the method disclosed above.

In a ninth aspect, a system is provided that includes one or more computers configured to perform the method disclosed above.

In a tenth aspect, a method is disclosed for deriving maps of relevant business processes and process flows that includes providing a hierarchy of maps of relevant business processes and process flows each of which is unique to an industry or process category, receiving a user's selection of a map or process flow, customizing the map or process flow in response to user input, and providing a customized map or process flow.

An eleventh aspect is an article comprising a computer-readable medium storing computer-executable instructions that when applied to one or more computers causes the computers to perform the method disclosed above.

In a twelfth aspect, a system is provided that includes one or more computers configured to perform the method disclosed above.

In various implementations, the above techniques may provide one or more of the following advantages. In certain embodiments, the techniques may identify the most relevant business processes and collaborative business processes. In certain embodiments, the techniques may help identify solutions to optimize business processes. In certain embodiments, the techniques may help provide customized maps of business processes for ease of comprehension. In certain embodiments, the map may also document the resulting value potential in a graphical representation. The graphical representation may be more easily comprehended than a written description. In certain embodiments, the map may also help enterprises identify the scenarios with strategic relevance for their business. The maps may also help identify scenarios offering a high return on investment.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a diagram of a value chain of a particular industry (Oil and Gas) according to one implementation.

FIG. 2 is a block diagram of a computer system according to one implementation.

FIG. 3 is a process flow diagram of map development techniques according to one implementation.

FIGS. 4A-4C are flow charts of map development techniques according to one implementation.

FIGS. 5A-5G depict output from map development techniques according to one implementation.

Like reference symbols in the various drawings indicate like elements.

### DETAILED DESCRIPTION OF ILLUSTRATIVE EMBODIMENTS

Certain illustrative embodiments of the invention relate to business decision making tools for various types of businesses. Selected embodiments also relate to tools for generating maps of collaborative business systems, identifying information technology (IT) tasks performed within the collaborative business systems, and determining an array of potential implementations to facilitate those tasks. Methods and systems consistent with the present invention can, in certain embodiments, provide collaboration between members of an e-community within a Collaborative Business Scenario (CBS).

Enterprises may desire to optimize value chains within a given industry. CBSs provide a tool to analyze, plan, and optimize value chains for an enterprise within a given industry. The CBS may perform value chain optimizations for not only one enterprise but also for other business participants beyond the confines of one enterprise. For example, in an oil and gas enterprise, CBSs may involve engineering project collaboration with engineering suppliers, collaborative planning with distributors, or collaborative forecasting and replenishment with service stations retailers.

Collaborative Business Scenarios are thus inter-enterprise business processes that include different participants with their specific responsibilities. In C-Business Scenarios, employees in different companies perform different tasks and duties with a common business goal. The participating businesses exchange information and define responsibilities for individual activities. Some examples are Collaborative Engineering and Project Management, Collaborative Supply and Demand Planning, and Vendor Managed Inventory. The C-Business Scenarios use software applications that are usually distributed among different companies and that can be used to exchange business data.

A solution map is a tool help visualize, plan and implement an information technology solution within a company. In order make the solution map more comprehensible, at least two views may be provided. The first view may provide a broad picture of the main processes within each industry. These main processes may be arranged in process categories and represent important business processes in an industry. The second view may provide a more detailed view of the specific functionality required for each process. A detailed description of each process may be provided.

A solution composer tool can help a user to visualize, plan, and implement information technology solutions that integrate business processes within an enterprise and between enterprises. The solution composer may provide a means to create and edit solution maps and CBS maps. The composer tool may also provide a means for planning an implementation project and for defining, documenting and communicating the solution requirements.

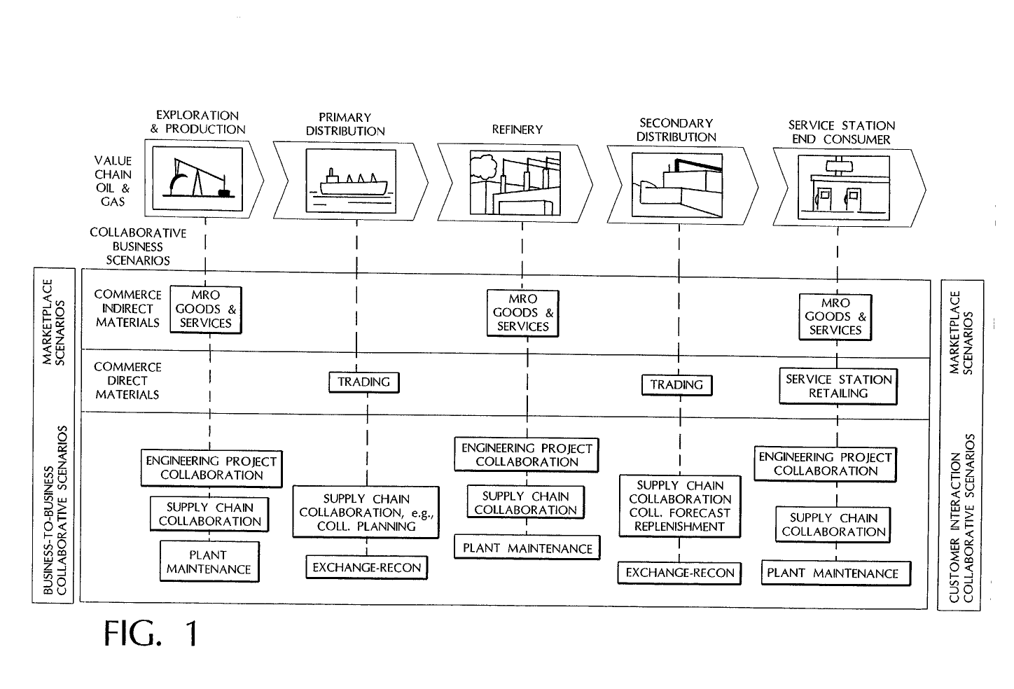

FIG. 1 depicts an exemplary oil and gas five-step value chain and various Collaborative Business Scenarios (CBSs) for the oil and gas value chain. The value chain starts with exploration and production of oil and ends with providing the oil at a service station, as indicated in FIG. 1.

The CBSs may consist of categories, such as business-to-business scenarios, marketplace scenarios, or customer interaction scenarios. In the business-to-business scenario, the participants are enterprises; in the marketplace scenario, enterprises cooperate at a single marketplace; and in the customer interaction scenario, a single customer is served by multiple enterprises.

A CBS can be used in a variety of industries or business communities. The CBS may consist of various entities, such as participants (e.g., importers, suppliers OEMs, manufacturers, distributors, vendors, sellers, end-customers, insurance companies, publishing companies, service companies, paper manufacturer), activities (e.g., order tracking, receipt processing, production, search requests), information sharing (e.g., business documents, status reports, purchase orders), document flow features (e.g., a search for specified vehicles), roles (e.g., employee roles such as a strategic purchaser), business benefits (e.g., improved buying power, reduced delivery times, cost advantages, increased customer satisfaction), value potential (e.g., 50% increase), type of CBS (e.g., Business to Business Scenarios, Marketplace Scenario, Customer Interaction Scenario), and the relationship to a Solution Map, all described below.

Each participant in a CBS acts according to a specific role (e.g., an employee that purchases goods is a purchaser), and each activity contains functionality and relates to a participant's role. CBSs also contain business documents, information flow, and systems landscapes (e.g., roles of the systems, software components, software releases, information to exchange between each system, and functions to process exchanged information within a system). Various aspects of CBSs are also described below. The CBS enables a top-down approach to optimize the value chain between enterprises. This allows the inter-company processes as well as cross-industry processes to be described. The CBS also provides an intuitive graphical design illustrating various collaborative aspects. The various illustrations, although directly derived from one another, cover separate aspects, offer complementary information (e.g., business view, interaction view, components view), and define business benefits for various participants. Moreover, the illustrations explain the contribution of each participant of inter-company collaboration to value creation.

In addition, the CBS enables discussion between business partners on new business opportunities using inter-company collaboration. The CBS facilitates discussions between companies and business partners regarding business benefits as well as discussions with software vendors on the feasibility and scope of required software solutions as well as its subsequent implementation. For example, software vendors provide specified functionality that fits into a specific activity of a CBS. Thus, participants may choose to agree with vendors regarding the standards used to exchange documents between activities.

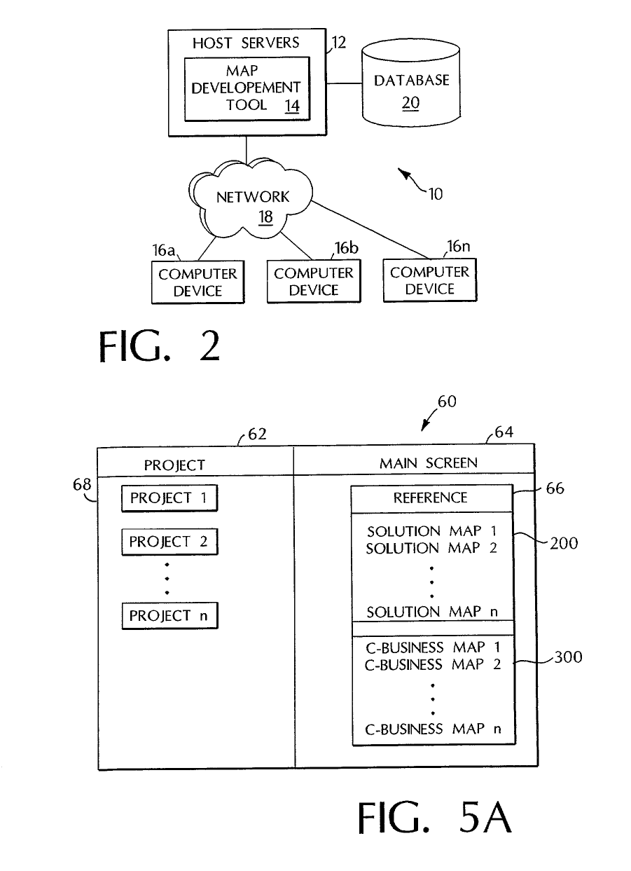

FIG. 2 is a block diagram of an embodiment of a computer system 10 that includes one or more host servers 12 for implementing a map development tool 14. The tool 14 can be accessed by a user using computer devices (16a, 16b, . . . 16n ) over a network 18. The host servers 12 may include, for example, an Internet-accessible server. A database 20 may be used by the host servers 12 to store and retrieve information such as information related to the operation of the host servers 12, information related to the execution of the tool 14, or other information. The tool 14 provides a user with business maps such as maps of business processes (“solution maps”) and maps of business process flows (“collaborative-business maps”). Solution maps provide a blueprint of an industry's application landscape. Solution maps also provide a map and overview of business processes within an industry whereas collaborative business maps and a description of a collaborative end-to-end business processes that involve multiple participants within or outside the organization. For example, the tool 14 can provide a user, such as an original equipment manufacturer (OEM) in the automotive industry, with a solution map of the major processes in the automotive industry and a collaborative business map of the collaborative business processes between the OEM and other market participants in the industry such piece-part suppliers. These business maps can be modified according to the needs of the user or the industry being analyzed. The tool 14 can generate maps of collaborative business systems, identify information technology (IT) dependent tasks performed within the collaborative business systems, and determine an array of potential implementations to facilitate those tasks. The operation of the tool 14 and processing of the business maps are described in further detail below.

The tool 14 may be executed in at least two modes. In an online mode, the tool 14 can be distributed and executed on one or more host servers 12 and accessed by a user using a computer device such as 16a. Alternatively, in an offline mode, the user can download the tool 14 onto the computer device 16 from the host servers 12 and execute the tool on the computer device. The tool may also be obtained through distribution channels including diskettes and CD-ROM or other such media. The network 18 may include a plurality of devices such as servers, routers and switching circuits connected in an intranet, extranet or Internet configuration.

A user may use a computer device, such as computer device 16a, to access the host servers 12 over a network 18. The computer device 16a may include a personal computer (PC), personal digital assistant (PDA) or other device using wireless or wired communication protocols to access the host servers 12. The computer device 16a may be coupled to I/O devices (not shown) that may include a keyboard in combination with a pointing device such as a mouse to input data into the computer, a computer display screen and/or a printer to produce output from the computer, a storage resource such as a hard disk drive for storing and retrieving data for the computer, and/or other I/O devices. The computer device 16a also my include a database (not shown) to store and retrieve data related to the execution of the tool 14.

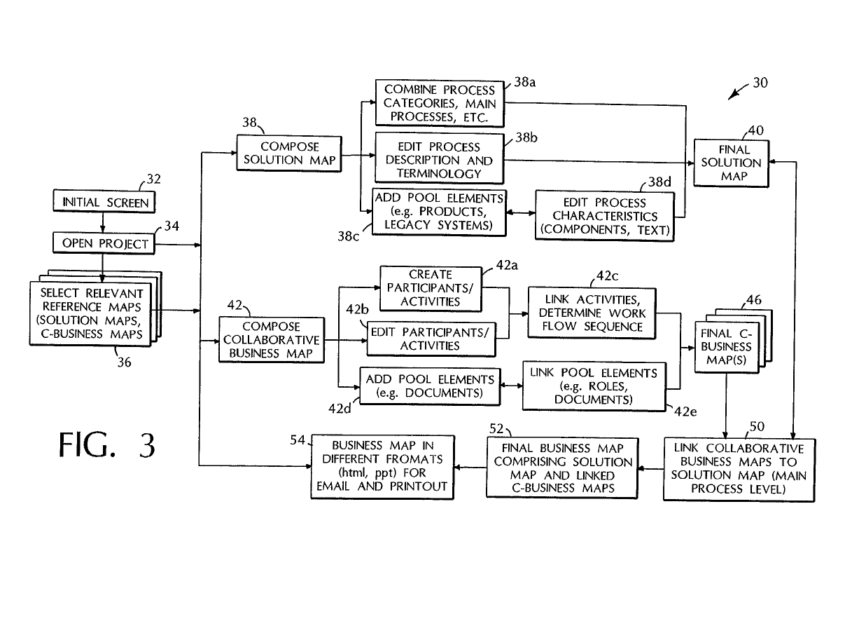

FIG. 3 is process flow diagram 30 illustrating the functionality of a map development tool 14 according to one implementation. The principles of the tool provide a platform that assist users in developing collaborative business maps.

After a user gains access to the tool 14, the tool displays an initial screen (block 32) using, for example, a graphical user interface (GUI). The tool 14 may allow the user to store business maps in project libraries (block 34) implemented using, for example, standard directory and/or file hierarchical data structures. The business maps that the user modifies from the project libraries can be selected (block 36) from a repository of relevant reference business maps that include solution maps and collaborative business maps.

The tool may permit users to compose solution maps (block 38), which in turn can display various business modules across one or more process-related planes. Users may be permitted to edit (blocks 38a-38d) any desired portion of the solution maps to, for instance, customize the map to particular industry sectors or process flows of interest. In selected embodiments, planes or modules of solutions maps can be copied to other solution maps, inserted, deleted, moved, and/or merged with other modules or planes.

The solution maps displayed by the tool may include links or references to more specific tasks and/or task-specific tools to facilitate performance of those tasks. The tool may be configured to permit the user to modify the specific tasks and/or the task-specific tools. Users and/or administrators may also be permitted to determine and specify associations between and among the specific tasks and/or additional tools.

Users can optionally implement the tool by composing (block 42) collaborative business maps pertinent to an industry of interest and show activity-based interactions among various industry participants. The tool can optionally be configured to permit users to edit (blocks 42a-42e) any desired aspect of the collaborative business map to, for instance, customize the collaborative business map to a particular industry sector or to reflect different participants or participant interactions or users'unique business needs, business and/or process models, market positions, or other aspects.

Briefly, collaborative business maps can include a collection of industry-specific and cross-industry process blueprints that define the activities, roles, system interfaces, and the business documents required for intra- or inter-enterprise collaboration. Collaborative business maps may also serve as a guide to the deployment of electronic business solutions to integrate existing resources amongst various individual enterprises.

The collaborative business maps optionally refer the user to or include descriptions of the participants and/or activities. The collaborative business maps can further include references, associations, or links to documents or other materials related to the task, participant, or process flow. The tools may include modules that permit a user to modify or customize any of the foregoing aspects of the collaborative business maps. They may also include modules that permit users to flexibly add new processes, activities, documents, and/or other related information to the collaborative business maps. For example, in certain embodiments, users may add new activities, sometimes called processes, to the collaborative business maps. In selected embodiments, users can also specify processes, links, or interactions among new or existing processes. Users may also be permitted to specify business documents associated with any such links or interactions. In certain embodiments, users can create pools such as product pools, and the pools may be associated with collaborative business maps and/or solution maps.

The tools can optionally permit the formation (blocks 50 and 52) of references, associations, or links between selected collaborative business maps (block 46) and solution maps (blocks 44). Some embodiments permit the addition or association of external files to collaborative business maps and/or solution maps. Various versions of the tools described herein may access information, such as additional information related to collaborative business maps or solution maps, via an Internet connection or the like.

Certain versions of the tool described herein permit users to export data and information, such as in the form of a report having a desired format (blocks 54). The tools may also permit the uploading of such exported data and information to Internet-accessible servers in a hypertext mark-up language (HTML) or other desired format.

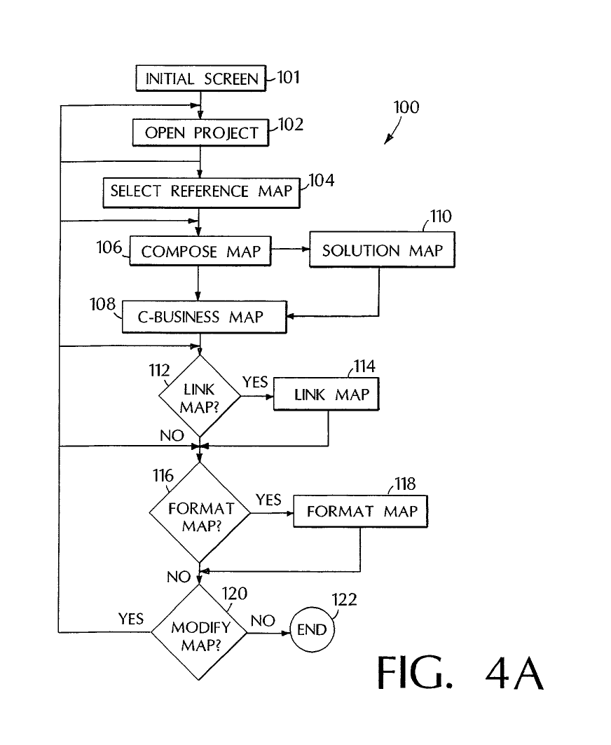

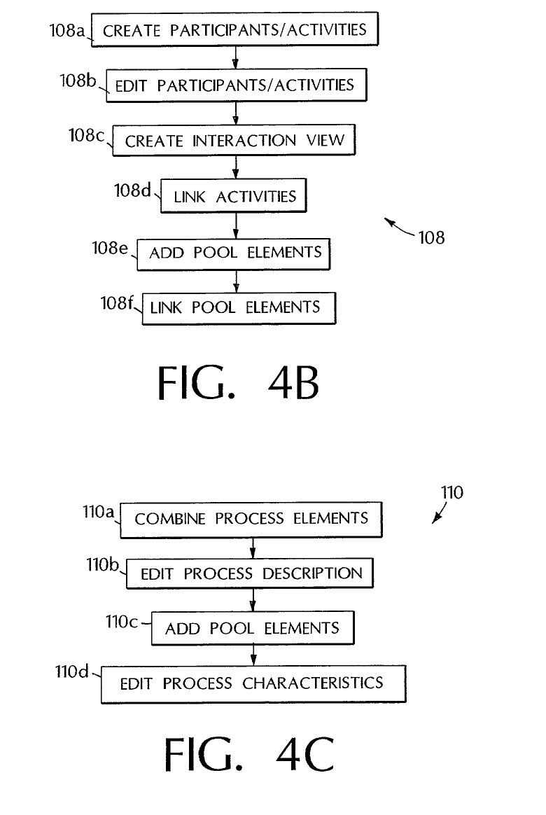

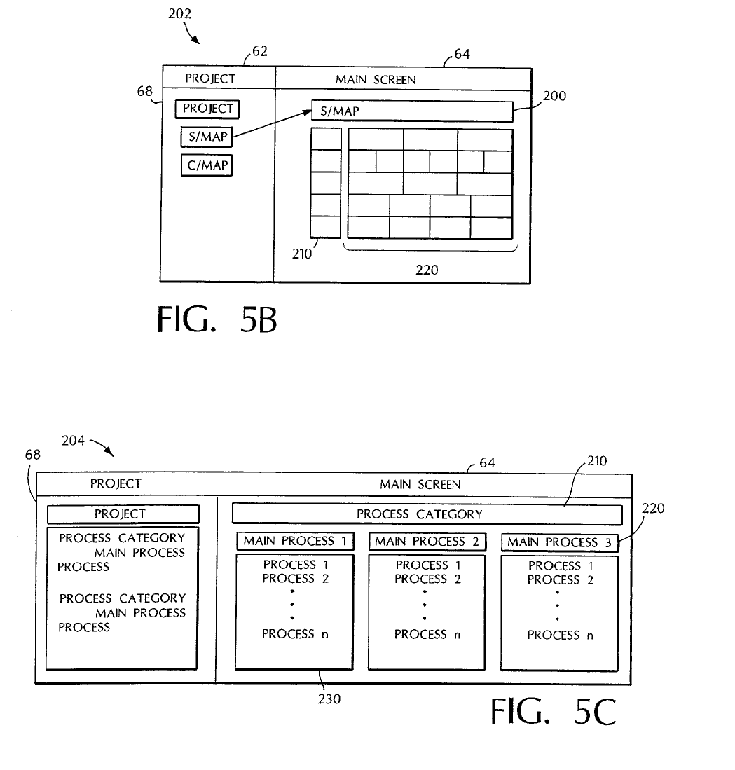

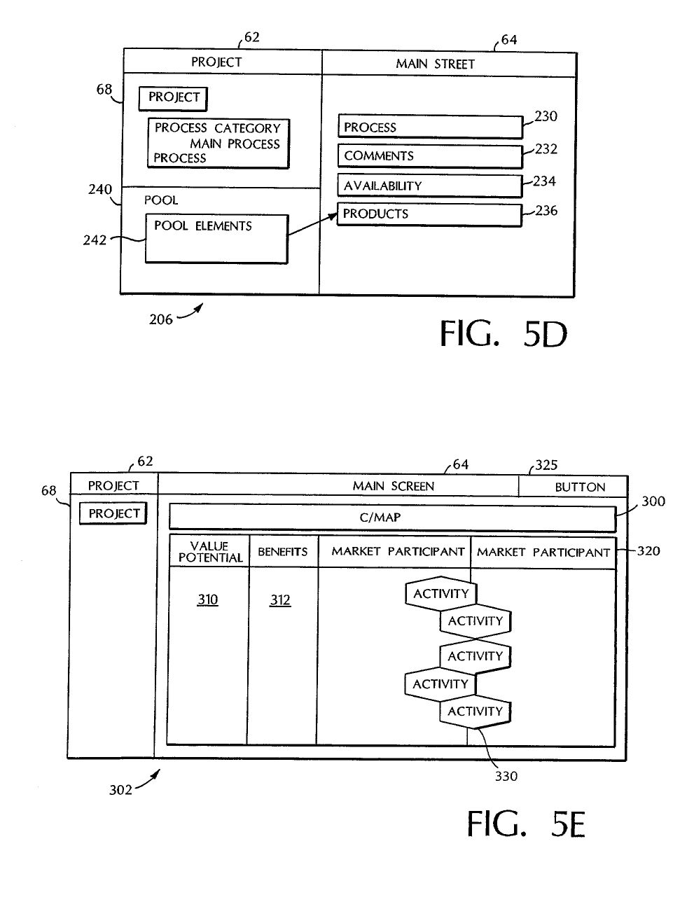

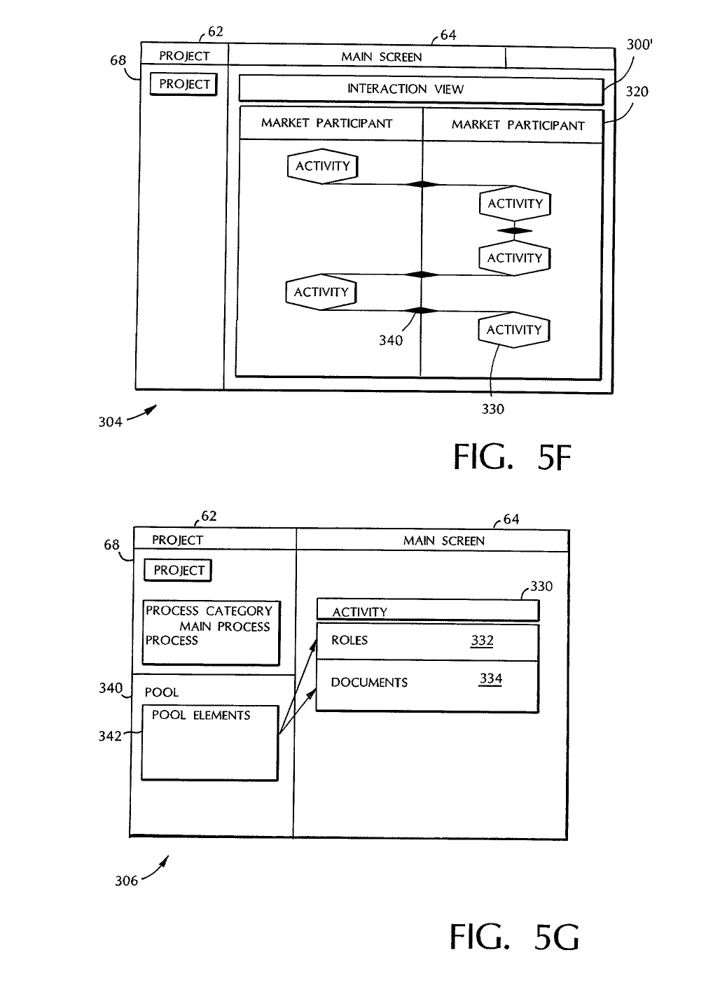

FIG. 4A is flow chart 100 illustrating the operation of a map development tool 14 according to one implementation. After a user gains access to the tool 14 using a computer device such as 16a, the tool may provide (step 101) the user with an initial screen display 60 (FIG. 5A) that is divided into a project screen area 62 and a main screen area 64. The main screen area 64 displays a reference library of business maps 66 that include solution maps 200 and collaborative business maps 300. The project screen area 62 allows the user to create project libraries 68 that include business maps which may be based on the business maps from the reference library 66. The initial screen 60 also can include standard computer screen techniques or features such as a menu bar, a mouse interface for selecting items from the screen, drag-and-drop methods, “drop-down” boxes, or other techniques.

The user can open one or more project libraries 68 (step 102) based on the particular industry sectors or process flows of interest to the user. For example, the user can create project libraries 68 for different aspects of an industry analysis. The user can then select (step 104) business maps from the reference library 66 which can then be copied to the project library 68. The user makes the selection based on the user's industry or on the industry that is of interest to the user. The selection function can be achieved using standard computer graphical selection techniques such as “drag-and-drop” or other selection techniques.

The tool allows the user to compose (step 106) collaborative business maps and/or solution maps. If the user decides to compose (step 108) a solution map, then the user selects a particular solution map from the project library 66. An exemplary solution map 200 is shown in screen display 202 in FIG. 5B. The solution map 200 is organized into rows called process categories 210 and columns within the process categories called main processes 220. The process categories 210 depict the most relevant business process categories for an industry. Likewise, the main processes 220 illustrate the most relevant business processes within process categories in an industry. For example, for an original equipment manufacturer (OEM) in the automotive industry, the tool may provide a process category 210 such as “supply chain planning and monitoring OEM” and provide corresponding main processes 220 such as “variant demand management”, “resource planning”, “order scheduling and sequencing”, “distribution planning”, or other main processes. Further aspects of the solution map are described in detail below.

As discussed above, the tool 14 allows the user to compose (step 110) a collaborative business map 300 as shown in screen display 302 in FIG. 5E. The screen display 302 provides a business view of the collaborative business map 300. The business view describes the participants and scope of the described business process from the business point of view and documents the business advantages of implementing a CBS. The business view of the collaborative business map 300, which may be a graphical representation of interlocking polygons (e.g., hexagons), enables the integration of common business purposes, and the ability to anticipate business benefits while implementing the CBS. Also, the business view of the collaborative business map 300 may provide value potential in terms of quantifiable business benefits (e.g. reduced delivery time by up to 75%) that allow return-on-investment (ROI) calculations to be formulated. The business view 300 illustrates collaboration between participants involved (e.g. OEM, importer, and dealer), types of CBS present, collaborative aspects between the participants, scope of the business collaboration, impact on the business and the value chain, anticipated business benefits, and quantifiable value potential.

Referring to FIG. 5E, the collaborative business map 300 comprises value potential 310, business benefits 312, participants 320, activities 330, and an interaction in one implementation view button 325. Participants 320 can be depicted in columns presented in different colors. Activities 330 illustrate the sequence and scope using interlocking hexagon-shaped boxes. Business benefits 312 consist of qualitative business benefits (e.g. improved market intelligence) and value potentials 310 list quantitative/quantifiable business benefits (e.g. reduced delivery times by up to 75%). For example, participants 320 such as a manufacturer and a supplier in the automotive industry may interact through activities 330 such as “plan new release”, “create new release”, “create Internet releases”, “confirm releases”, or other activities. Such activities may have benefits 312 such as “best data quality”, “tracking of all process steps at any time”, “significant increase in used of numbers of suppliers connected electronically”, or other benefits. Corresponding value potentials 310 may include “up to 50% reduced costs”, “from 30% up to 80%”, or other potentials. An interaction view button 325 may be provided to link between the business view of the collaborative business map 300 and an interaction view of the collaborative business map (described below). When the user selects button 325, the display changes from a business view to an interaction view.

After a solution map or a collaborative business map have been composed, the tool 14 (FIG. 4A) provides the user with an option to link (step 112) solution maps to collaborative business maps. A solution map is a technique that can be used to analyze strategies and activities for specified industries and preferably depicts a wide range of solutions for various activities. Thus, if a solution map contains information that corresponds to functionality of an activity 330 in a collaborative business map, the solution map may be linked (step 114) to the activity. As an example, solution maps relating to the automotive industry may apply to a vehicle sales CBS. And, if the automotive solution maps contain solutions that correspond to an activity for purchasing vehicles, a link may be created to that automotive solution map from the corresponding activity. This linking function is described in detail below.

The user can then format (step 116) the business maps into formats such as Microsoft Power Point, HTML electronic-mail (EMAIL), hard copy format such as a print out, or other formats. This may enable the information in the business maps to be transformed into different formats depending on the needs of the user. For example, the user can compose a collaborative business map and one or more solution maps as described above. The user may then wish to conduct a meeting and have the business maps presented in a power point presentation format. Such a format may be more appropriate than another format such as HTML or a simple unformatted hard copy print out. In addition, the user may wish to transmit the business map to another user in the organization who may be in a different location than the user. In such a case, the business maps can be formatted into an Email and sent to the other user over a network. Alternatively, the business maps can be transformed into a Web based format using, for example, HTML.

The tool 14 may allow the user to repeat (step 120) any of the above steps. For example, the user wish to open another new project library (step 102), select another reference business map (step 104), compose additional business maps (step 106), link additional business maps (step 112), or format business maps (step 116). On the other hand, the tool allows the user to end (step 122) the session with the tool and process further the maps including, for example, save, Email, edit, print, or other functions with the maps.

FIG. 4B is a detailed flow chart 108 of the map development tool 14 according to one implementation. The flow chart 108 illustrates the functions of the tool 14 involved in the composition of a collaborative business map such as business map 300 described above (see FIG. 5E). The tool 14 allows the user to create (step 108a) process elements such as market participants 320 and/or activities 330. For example, the user can add market participants 320 and/or activities 330 by selecting these elements from collaborative business maps that were previously stored in project libraries 68 and copy them to the collaborative business map 300 that is currently being modified. The selection function can be implemented using standard computer techniques such as “drag-and-drop.” The tool 14 also allows the user to edit market participants 320 and/or activities 330 using computer techniques.

Once the market participants and/or activities have been created, they can be edited (step 108b). For example, elements, such as market participants 320 and/or activities 330, can be removed from the collaborative business map 300 by selecting the element and deleting the element using standard techniques. In addition, the nomenclature or the description of the market participant 320 and/or the activities 330 can be edited. The tool then identifies the functionality of each activity and roles of participants that perform those activities, identifies various business documents, and identifies information flow between participants. For example, a role of an employee (participant) may be as a strategic purchaser, and the functionality may be to create vehicle pools, or search for new vehicles.

The tool can provide an interaction view (step 108c) of the collaborative business map 300′ as shown FIG. 5F. The interaction view 300′ is produced in response to the user selecting the interaction view button 325 (FIG. 5E) discussed above. The interaction view 300′ is derived directly from the business view 300 (FIG. 5E) and includes additional information identified above, regarding the elements of collaboration between the participants 320. That is, the interaction view may contain the dependencies between the individual activities within the entire process and the exchange of information between the business collaborators. The business documents are defined and specified. Also, the interaction view may link to the personalized roles and features included in the collaboration and enables a user to view the information exchange between participants 320, such as information sharing and/or document flow. Information sharing relates to having multiple participants view the same information so information is not duplicated. The term “document flow” refers to sending a document from one participant to another. Thereby, the document may be copied for the other participant. This is different from “information sharing”, where a document remains at its original location without being copied.

Interaction view 300′ depicts a sequence of collaborative activities between all participants, roles of the participants in the collaboration, detailed features for each of the collaborative activities information sharing between participants, business documents, and interfaces between the participants, thus illustrating the interdependency of the participants in the CBS. Both the business view 300 and the interaction view 300′ contain participants 320 and activities 330. However, the interaction view 300′ also includes links 340 between activities 330. For example, for participants such as an OEM and an importer in the automotive industry, the links 340 can includes business documents such as “vehicle configuration”, “quantity”, or other business documents. The links 340 also can identify roles of employees involved in the exchanges such as a “strategic purchaser” having duties that include “creating vehicles in a vehicle pool”, “searching for vehicles”, “maintaining vehicle status”, or other functions.

The tool allows the user to establish a link (step 108d) between the activities 330 associated with the participants 320. These links 340 between activities 320 depict the flow of information and/or exchange of business documents (e.g. sale orders) between participants 320. In one implementation, i.e., double triangles on each link 320 are coded (e.g., shaded) based on the sending participant 320. The linking function can be implemented using computer graphic techniques.

The user can select an activity 330 from the collaborative business map 300′ in order to add (step 108e) pool elements to the activity. Pool elements can include roles and business documents involved in the activities, key performance indicators (KPIs), service agreements, man-power resources, or other information. For example, for participants in the automotive industry, business documents can include “vehicle configuration”, “quantity”, or other business documents. The roles can include, for example, a “strategic purchaser” having duties that include “creating vehicles in a vehicle pool”, “searching for vehicles”, “maintaining vehicle status”, or other functions. For example, a business process, such as vendor managed inventory (VMI) may be affected by KPIs including lower administrative costs, improved purchasing process, and so on. A KPI may represent a factor that affects the business process. As a result of the selection, the tool displays a screen 306 (FIG. 5G) that includes an activity 330 and a pool area 340 that includes pool elements 342. The activity 330 includes a role element portion 332 and a document element portion 334. The role element portion 332 refers to elements of collaboration between the participants. For example, the role element 332 can refer to a role of an employee (participant) in the activity. The document element 334 can refer to documents that are shared or exchanged between participants 320. The user may add these elements by selecting pool elements from a pool element library 342 and copying them to the role and/or document element portions 332, 334. The tool may allow the user to change, edit, or replace the role and/or document element portions 332, 334. Standard computer techniques can be used to perform these operations.

FIG. 4C is a detailed flow chart 110 of a solution map development tool 14 according to one implementation. As discussed above, the tool 14 allows a user to compose a solution map such as solution map 200 as shown in screen display 202 in FIG. 5B. As discussed above, main processes 220 are associated with process categories 210 and each main process is associated with business processes (described below) which the user can modify. The user can select a process category 210 which causes the tool 14 to display a process category screen display 204 as shown in FIG. 5C. The process category screen 204 includes the process category 210 selected by the user and the main processes 220 associated with the selected process category. The screen 204 may also show relevant business processes 230 associated with each main process. The relevant business processes 230 are processes that may be used to implement the respective main process.

The tool provides functionality to combine (step 110a) additional process elements to the process category 210 in FIG. 5C. For example, the user can add processes to the process list 230 by copying processes from the project library 68 to the process list 230. Likewise, the user can add additional main processes 220 and process categories 210 by copying these elements from the project library 68.

The user can select a process 230 to modify a process description (step 110b) associated with the selected process. The user selects a process 230 from FIG. 5D which causes the tool 14 to display a screen display 206 (FIG. 5D) of the selected process 230. The process 230 shows a process description area 232, an availability area 234, and a products area 236. The process description area 231 provides a description of the process 230 which the user can edit. The availability area 234 indicates the availability of a product associated with the selected process. For example, the availability area 234 can indicate whether a product, such as a program, is currently available or available in the future. The products area 236 can include links to programs or applications that can be used to implement the process 230.

Additional pool elements (i.e. products) can be added (step 110c) to the products area 236 from a pool elements section 244 in the pool portion of the screen 240. The pool elements section 244 provides elements such as programs that can be used to implement processes. Thus, the user can add an element such as a sales order program from the pool elements section 244 to the products area 236. This allows the user to specify a process 230 that refers to products such as programs that may be used to implement the process.

The elements in the process 230 shown in screen 206 can be edited (step 110d) by the user. For example, the user can edit the process description area 232 to reflect, for example, the function of the process 230.

Those skilled in the art will appreciate from the foregoing description that the methods and apparatus identified herein may be advantageously modified in an almost limitless number of ways. For instance, one or more of the foregoing techniques may be advantageously performed in isolation or in any desired combination or order. The software may be configured to be executed on any variety of platforms, such as intranets, wireless networks, and local hard disks by way of non-limiting example. The software may be executed on one or more computers, host servers or distributed host servers. The systems and techniques described herein may be implemented in environments without software, including as “paper and pencil” versions. Any amount of proprietary content may be incorporated into this system, such as propriety business models, industry trends, and market forces. Any aspect of the business strategy evaluation, value calculations, etc. may be implemented at a finer granularity by use of more detailed information, models, inputs and/or algorithms, for example. None of the particular techniques need be performed in the order indicated unless specifically stated. To the contrary, the techniques may be freely modified by substituting and/or reordering steps as suitable for particular implementations. Any output from the system described herein may be presented in any manner suitable for a particular user, and may include any aspect of the business strategies, industry trends, and market forces described herein.

Various features of the system may be implemented in hardware, software, or a combination of hardware and software. For example, some aspects of the system may be implemented in computer programs executing on programmable computers. Each program may be implemented in a high level procedural or object-oriented programming language to communicate with host servers.

Furthermore, each such computer program may be stored on a storage medium, such as read-only-memory (ROM), readable by a general or special purpose programmable computer, for configuring and operating the computer when the storage medium is read by the computer to perform the functions described above.

What is claimed is:

1. A method for deriving a map of relevant business processes comprising:
receiving a user's selection of an industry or process category;
providing a map of business processes relevant to the user's selection;
modifying at least one of nomenclature, processes, process categories, main processes, or pool elements associated with the map in response to the user's selection; and
providing a customized map of relevant business processes.

2. The method of claim 1, wherein modifying includes at least one of adding, deleting, or editing at least one of the nomenclature, processes, process categories, main processes, or pool elements associated with the map in response to the user's selection.

3. The method of claim 1 wherein pool elements includes application programs associated with implementing a process.

4. The method of claim 1 wherein each process category includes a grouping of business processes most relevant to an industry, wherein the process category is associated with main processes representing the functionality required for each process category.

5. The method of claim 1 wherein main processes includes business processes required to implement the main processes.

6. The method of claim 1 further comprising displaying the customized map.

7. The method of claim 1 wherein the map of business processes includes a solution map.

8. A method for deriving a business process flow comprising:
receiving a user's selection of one or more business process flows including market participants and activities;
modifying at least one of market participants, activities, or pool elements associated with the business process flow in response to a user's selection;
associating activities with participants; and
providing a customized map of relevant process flows.

9. The method of claim 8 further comprising associating pool elements to process flows.

10. The method of claim 8 wherein pool elements includes information related to at least one a role of a participant associated with an activity and key performance indicators.

11. The method of claim 8 wherein pool elements includes at least one of a business documents associated with at least one activity and key performance indicators.

12. The method of claim 8 wherein modifying includes at least one of adding, deleting, or editing at least one of the market participants, activities, or pool elements associated with the business process flow in response to a user's selection.

13. The method of claim 8 further comprising displaying the customized map.

14. A method for linking relevant business processes and flows comprising:
providing a map of relevant business processes including a plurality of main processes;
providing one or more business process flows;
associating a plurality of main processes with one or more business process flows; and
generating maps and process flows having main processes associatively linked to one or more business process flows.

15. The method of claim 14 wherein business process flows includes collaborative business maps.

16. The method of claim 14 wherein the map of relevant business processes includes a solution map.

17. The method of claim 14 further comprising creating a link between or among process flow elements associated with business process flows.

18. The method of claim 17 wherein process flow elements includes at least one of activities, participants, and pool elements.

19. The method of claim 14 further comprising creating a link between or among business map elements associated with the map of relevant business processes.

20. The method of claim 19 wherein business map elements include at least one of a process categories, main processes, and processes.

21. A method for deriving maps of relevant business processes and process flows comprising:
providing a hierarchy of maps of relevant business processes and process flows each of which is unique to an industry or process category;
receiving a user's selection of a map or process flow;
customizing the map or process flow in response to user input; and
providing a customized map or process flow.

22. The method of claim 21 wherein the maps of relevant business processes includes a solution map.

23. The method of claim 21 wherein the process flow includes a collaboration business map.

24. The method of claim 21 wherein customizing includes modifying at least one of nomenclature, processes, process categories, main processes, or pool elements associated with the map in response to the user's selection.

25. The method of claim 24 wherein modifying includes at least one of adding, deleting, or editing at least one of the nomenclature, processes, process categories, main processes, or pool elements associated with the map in response to the user's selection.

26. The method of claim 21 wherein customizing includes modifying at least one of market participants, activities, or pool elements associated with the business process flow in response to a user's selection.

27. The method of claim 26 wherein modifying includes at least one of adding, deleting, or editing at least one of the market participants, activities, or pool elements associated with the business process flow in response to a user's selection.

28. An article comprising a computer-readable medium storing computer-executable instructions that when applied to one or more computers cause the computers to:
receive a user's selection of an industry or process category;
provide a map of business processes relevant to the user's selection;
modify at least one of nomenclature, processes, process categories, main processes, or pool elements associated with the map in response to the user's selection; and
provide a customized map of relevant business processes.

29. The article of claim 28 wherein modify includes at least one of add, delete, or edit at least one of the nomenclature, processes, process categories, main processes, or pool elements associated with the map in response to the user's selection.

30. The article of claim 28 wherein pool elements includes application programs associated with implementing a process.

31. The article of claim 28 wherein each process category includes a grouping of business processes most relevant to an industry, wherein the process category is associated with main processes representing the functionality required for each process category.

32. The article of claim 28 wherein main processes includes business processes required to implement the main processes.

33. The article of claim 28 further comprising computer-executable instructions to display the customized map.

34. The article of claim 28 wherein the map of business processes includes a solution map.

35. A system for deriving a relevant business process, the system comprising one or more computers configured to:
receive a user's selection of an industry or process category;
provide a map of business processes relevant to the user's selection;
modify at least one of nomenclature, processes, process categories, main processes, or pool elements associated with the map in response to the user's selection; and
provide a customized map of relevant business processes.

36. The system of claim 35 wherein modify includes at least one of add, delete, or edit at least one of the nomenclature, processes, process categories, main processes, or pool elements associated with the map in response to the user's selection.

37. The system of claim 35 wherein pool elements includes application programs associated with implementing a process.

38. The system of claim 35 wherein each process category includes a grouping of business processes most relevant to an industry, wherein the process category is associated with main processes representing the functionality required for each process category.

39. The system of claim 35 wherein main processes includes business processes required to implement the main processes.

40. The system of claim 35 further comprising computer-executable instructions to display the customized map.

41. The system of claim 35 wherein the map of business processes includes a solution map.

42. An article comprising a computer-readable medium storing computer-executable instructions that when applied to one or more computers cause the computers to:
receive a user's selection of one or more business process flows including market participants and activities;
modify at least one of market participants, activities, or pool elements associated with the business process flow in response to a user's selection;
associate activities with participants; and
provide a customized map of relevant process flows.

43. The article of claim 42 further comprising associating pool elements to process flows.

44. The article of claim 42 wherein pool elements includes at least one of information related to a role of a participant associated with an activity, key performance indicators, and products.

45. The article of claim 42 wherein pool elements includes at least one of business documents associated with at least one activity, key performance indicators, and products.

46. The article of claim 42 wherein modifying includes at least one of adding, deleting, or editing at least one of the market participants, activities, or pool elements associated with the business process flow in response to a user's selection.

47. The article of claim 42 further comprising displaying the customized map.

48. A system for deriving a business process flow, the system comprising one or more computers configured to:
receive a user's selection of one or more business process flows including market participants and activities;
modify at least one of market participants, activities, or pool elements associated with the business process flow in response to a user's selection;
associate activities with participants; and
provide a customized map of relevant process flows.

49. The system of claim 48 further comprising associating pool elements to process flows.

50. The system of claim 48 wherein pool elements includes at least one of information related to a role of a participant associated with an activity, key performance indicators, and products.

51. The system of claim 48 wherein pool elements includes at least one of business documents associated with at least one activity, key performance indicators, and products.

52. The system of claim 48 wherein modify includes at least one of to add, delete, or edit at least one of the market participants, activities, or pool elements associated with the business process flow in response to a user's selection.

53. The system of claim 48 further comprising displaying the customized map.

54. An article comprising a computer-readable medium storing computer-executable instructions that when applied to one or more computers cause the computers to:
provide a map of relevant business processes including a plurality of main processes;
provide one or more business process flows;
associate a plurality of main processes with one or more business process flows; and
generate maps and process flows having main processes associatively linked to one or more business process flows.

55. The article of claim 54 wherein business process flows includes collaborative business maps.

56. The article of claim 54 wherein the map of relevant business processes includes a solution map.

57. The article of claim 54 further comprising computer-executable instructions to create a link between or among process flow elements associated with business process flows.

58. The article of claim 57 wherein process flow elements includes at least one of activities, participants, and pool elements.

59. The article of claim 54 further comprising computer-executable instructions to create a link between or among business map elements associated with the map of relevant business processes.

60. The article of claim 59 wherein business map elements include at least one of a process categories, main processes, and processes.

61. A system for linking relevant business processes and flows, the system comprising one or more computers configured to:
provide a map of relevant business processes including a plurality of main processes;
provide one or more business process flows;
associate a plurality of main processes with one or more business process flows; and
generate maps and process flows having main processes associatively linked to one or more business process flows.

62. The system of claim 61 wherein business process flows includes collaborative business maps.

63. The system of claim 61 wherein the map of relevant business processes includes a solution map.

64. The system of claim 61 further comprising computers configured to create a link between or among process flow elements associated with business process flows.

65. The system of claim 64 wherein process flow elements includes at least one of activities, participants, and pool elements.

66. The system of claim 61 further comprising computers configured to create a link between or among business map elements associated with the map of relevant business processes.

67. The system of claim 66 wherein business map elements include at least one of a process categories, main processes, and processes.

68. An article comprising a computer-readable medium storing computer-executable instructions that when applied to one or more computers cause the computers to:
provide a hierarchy of maps of relevant business processes and process flows each of which is unique to an industry or process category;
receive a user's selection of a map or process flow;
customize the map or process flow in response to user input; and
provide a customized map or process flow.

69. The article of claim 68 wherein the maps of relevant business processes includes a solution map.

70. The article of claim 68 wherein the process flow includes a collaboration business map.

71. The article of claim 68 wherein customize includes a modification of at least one of nomenclature, processes, process categories, main processes, or pool elements associated with the map in response to the user's selection.

72. The article of claim 71 wherein modify includes at least one of to add, delete, or edit at least one of the nomenclature, processes, process categories, main processes, or pool elements associated with the map in response to the user's selection.

73. The article of claim 68 wherein customize includes a modification of at least one of market participants, activities, or pool elements associated with the business process flow in response to a user's selection.

74. The article of claim 73 wherein modify includes at least one of to add, delete, or edit at least one of the market participants, activities, or pool elements associated with the business process flow in response to a user's selection.

75. A system for deriving maps of relevant business processes and process flows, the system comprising one or more computers configured to:
provide a hierarchy of maps of relevant business processes and process flows each of which is unique to an industry or process category;
receive a user's selection of a map or process flow;
customize the map or process flow in response to user input; and
provide a customized map or process flow.

76. The system of claim 75 wherein the maps of relevant business processes includes a solution map.

77. The system of claim 75 wherein the process flow includes a collaboration business map.

78. The system of claim 75 wherein customize includes a modification of at least one of nomenclature, processes, process categories, main processes, or pool elements associated with the map in response to the user's selection.

79. The system of claim 71 wherein modify includes at least one of to add, delete, or edit at least one of the nomenclature, processes, process categories, main processes, or pool elements associated with the map in response to the user's selection.

80. The system of claim 75 wherein customize includes a modification of at least one of market participants, activities, or pool elements associated with the business process flow in response to a user's selection.

81. The system of claim 73 wherein modify includes at least one of to add, delete, or edit at least one of the market participants, activities, or pool elements associated with the business process flow in response to a user's selection.
